(19) United States
(12) Patent Application Publication
(10) Pub. No.: US 2010/0011090 A1
(43) Pub. Date: Jan. 14, 2010

(54) NETWORK-AWARE DOWNLOAD MANAGER

(75) Inventor: Michael M. Gordon, Paradise Valley, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Limelight Networks, Inc., Tempe, AZ (US)

(21) Appl. No.: 12/502,804

(22) Filed: Jul. 14, 2009

Related U.S. Application Data
(60) Provisional application No. 61/080,597, filed on Jul. 14, 2008.

(51) Int. Cl. G06F 15/173

(52) U.S. Cl. 709/218

(57) ABSTRACT

A download management system is disclosed. A number of download managers on a local area network (LAN) expressly negotiate bandwidth allocations with a politeness coordination function. Some bandwidth is consumed without the express negotiation and the politeness coordination function characterizes those while allocating an estimated bandwidth to provide adequate QoS. Some download managers can have their stream or download scheduled for a later time if adequate bandwidth is unavailable. The upstream connection to the Internet or wide area network (WAN) can be scheduled efficiently for computing devices that may or may not have a download manager capable of the express negotiation.

This application claims the benefit of and is a non-provisional of co-pending U.S. Provisional Application Ser. No. 61/080,597 filed on Jul. 14, 2008, which is hereby expressly incorporated by reference in its entirety for all purposes.

### BACKGROUND

This disclosure relates in general to content downloading and, but not by way of limitation, to Internet download of remote content files.

Browsers and operating systems have the ability to manage the download of files. Operations such as regulating the download, pausing download and resuming download are operations common to these download managers. Bandwidth management can also be provided within a user computing device where the Internet connection or computer processor is not overwhelmed in performing the download. Some download managers can specify immediate download or download to be performed at a later time. The download manager can hold a history of past downloads and current download tasks.

There are many different download managers used on a typical computing device. For example, there are separate download managers for video playback, music streaming or download, software download, software upgrades, etc. In addition to computers having a number of download managers installed on each computer, a home or business often has a number of computing devices. These computing devices include phones, personal digital assistants, media playing software or hardware, portable computers, desktop computers, set top boxes, and personal video recorders. Additionally, other devices on a network use the Internet connection such as VoIP phone lines, alarm systems, video cameras, etc. All these devices share a common Internet connection at the home or business without any coordination on usage.

### SUMMARY

In one embodiment, the present disclosure provides various download managers on a network that can coordinate sharing of an Internet connection or other network bottleneck. Alternatively, a download controller, standalone or embedded in a router or other device, can coordinate downstream users of the upstream connection.

In another embodiment, a download management system is disclosed. A number of download managers on a local area network (LAN) expressly negotiate bandwidth allocations with a politeness coordination function. Some bandwidth is consumed without the express negotiation and the politeness coordination function characterizes those while allocating an estimated bandwidth to provide adequate QoS. Some download managers can have their stream or download scheduled for a later time if adequate bandwidth is unavailable. The upstream connection to the Internet or wide area network (WAN) can be scheduled efficiently for computing devices that may or may not have a download manager capable of the express negotiation.

In yet another embodiment, a download system for electronically receiving content files from a number of sources with a number of user computing devices, the download system is disclosed. A politeness coordination function is in communication with the number of user computing devices. A network interface is coupled to a number of download managers distributed among the number of user computing devices. The politeness coordination function gathers a number of download tasks from the number of download managers. A data store holds a download task list. The download task list includes the number of download tasks reported from the number of download mangers. Each of the number of download tasks includes a requested bandwidth. The download task list includes a number of unreported download tasks determined from automatically observing addresses sending or receiving information. The politeness coordination function allocates and/or schedules download task list over a wide area network (WAN) connection shared by the number of user computing devices.

In an embodiment, a method for controlling use of bandwidth to a wide area network (WAN) used by a local area network (LAN) including a number user computing devices. The method includes accumulating a number of download tasks from a number of download managers distributed among the number of user computing devices, each of the number of download tasks indicating a desired bandwidth. It also prioritizes the number of download tasks. A fraction of the bandwidth for uses not reflected in the number of download tasks is determined. Bandwidth for the number of download tasks is allocated.

In an embodiment, a download system for electronically receiving content files from a number of sources with a number of user computing devices is disclosed. The download system comprising a politeness coordination function, a network interface, a data store. The politeness coordination function is in communication with the number of user computing devices. The network interface is coupled with a number of download managers distributed among the number of user computing devices. The politeness coordination function gathers a number of download tasks from the number of download managers. The data store holds a download task list. The download task list includes the number of download tasks reported from the number of download mangers. The politeness coordination function allocates and/or schedules bandwidth over a wide area network (WAN) connection shared by the number of user computing devices.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIGS. 1A and 1B depict block diagrams of embodiments of a local area network (LAN) having a number of download managers;

FIGS. 2A, 2B and 2C depict block diagrams of embodiments of a download system; and

FIG. 3 illustrates a flowchart of an embodiment of a process for managing bandwidth consumption on a LAN.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

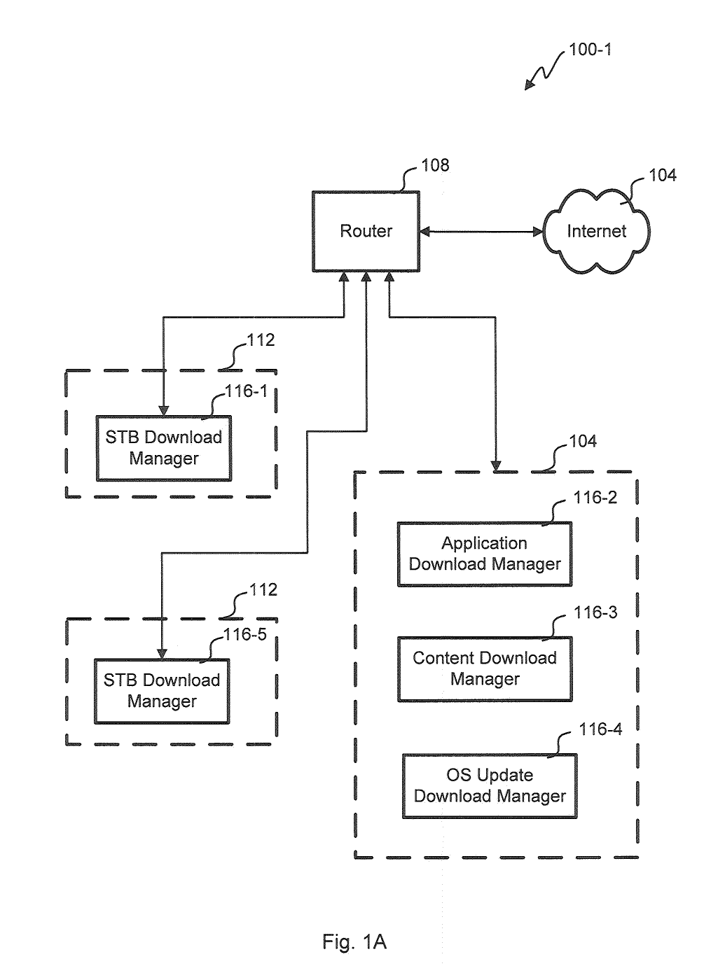

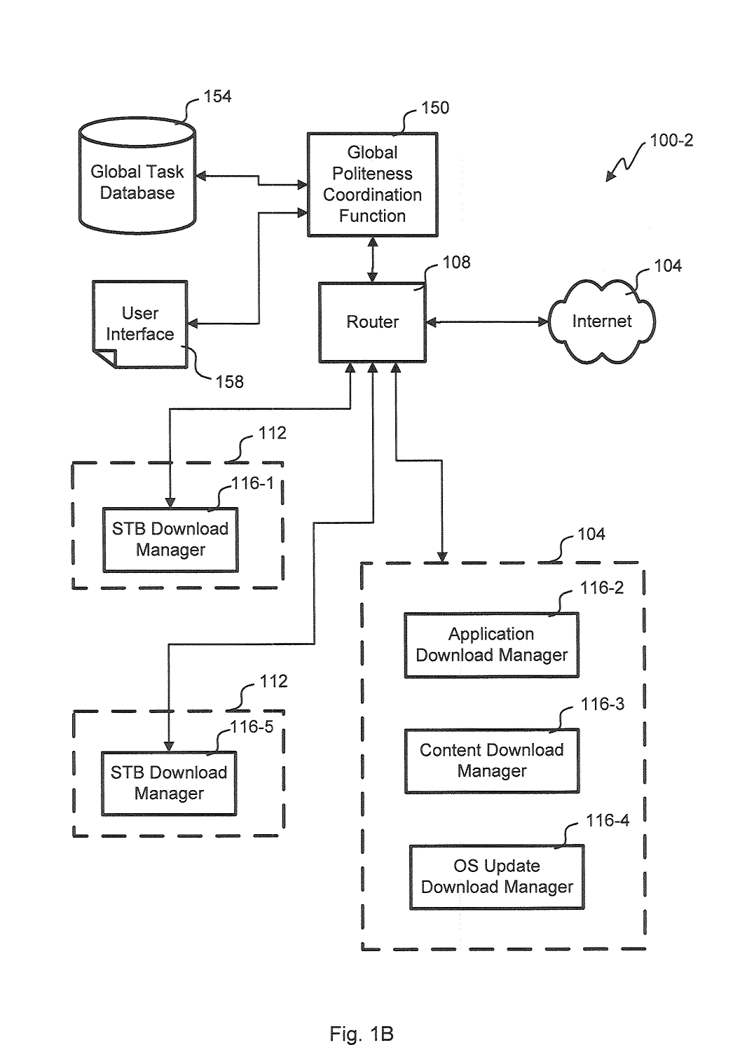

Referring first to FIG. 1A, an embodiment of a local area network (LAN) 100-1 having a number of download managers 116 is shown coupled to the Internet 104. This embodiment of the system 100-1 is a typical home installation including two set top boxes (STBes) 112 and a personal computer 104. Other embodiments could have any number of computing devices each with one or more download managers. Each of the STBs 112, has a STB download manager 116-1, 116-5 to receive content files through a router 108, which communicates with a wide area network (WAN) or the Internet. The router 108 in this embodiment is also networked to the personal computer 104, which has an application download manager 116-2, a content download manager 116-3, an operating system (OS) download manager 116-4 and possibly other download managers. In various LAN embodiments, each STB 112, video player, music player, personal computer 104, computing device, electronic device can have one or more download managers.

The various download managers 116 each gather information about download tasks that are planned or in operation. The download tasks can be user requested content, scheduled content, delayed downloads or any file or streamed download. Each download manager 116 communicates to other download managers 116 these planned or operational download tasks to allow download tasks to be known among those download managers 116 sharing a download resource. In other words, the planned download task information is gathered and communicated away from each download manager 116 to other download managers to allow coordination of the bandwidth usage on a shared network connection. Collectively, the download managers 116 work together to share the download resources of the network connection in a prioritized manner as will be further described below. Each download manager 116 can discover other download managers 116 on the same LAN and routing information for the upstream network connection can be compared to determine if each is sharing a common Internet or WAN connection.

In this embodiment, the download managers 116 communicate pending and operational download tasks with each other such that each download manager 116 can determine how much of bandwidth to utilize. In another embodiment, a single controller or global politeness coordination function on the local area network (LAN) decides how the bandwidth should be utilized based upon the information about the planned and operational download tasks. The global politeness coordination function may be embedded in a device that acts as a gateway to the Internet or other wide area network, in a router, in another device, or may be a standalone device. In yet another embodiment, each download manager 116 communicates pending and operational download tasks to a global politeness coordination function on the wide area network or Internet that arbitrates how the bandwidth will be utilized for a particular group of download managers. Still another embodiment, allows some download managers to gather the information from other download managers for making a local decision, while other download managers work with a controller on the Internet or LAN to allow remote arbitration.

With reference to FIG. 1B, another embodiment of a local area network LAN 100-2 of download managers 116 is shown coupled to the Internet 104. This embodiment uses a point on the LAN 100-2 to arbitrate usage of the Internet connection for some or all of the download managers 116. A global politeness coordination function 150 receives reports from the download managers 116 of download tasks and recent activity/inactivity of the computing device 102, 112. Those reports are stored in a global task database 154. The global politeness coordination function 150 uses the information in the global task database 154 in a politeness algorithm to allocate the Internet connection among the various download managers 116 and other possible consumers of the bandwidth on the LAN 100. Other embodiments could also coordinate usage of bandwidth and resources on the LAN 100.

By having the control point in communication with a network bottleneck such as a router 108, all downstream consumers of the bandwidth can be controlled irrespective of whether the downstream consumer is a download manager 116 with the ability to report download tasks and accept allocations and scheduling. Historical usage of ports/IP addresses can be monitored by the global politeness coordination function 150 to determine the typical and maximum usage of the Internet connection. That usage is stored in the global task database 154. Other embodiments could embed the global politeness coordination function 150, the global task database 154 and user interface 158 in the router 108 itself or could have a separate appliance to host these functions.

A user interface 158 could be a web or application interface that allows interaction with the global politeness coordination function 150. The user interface 158 could report allocations and schedules of the upstream bandwidth between the LAN and the WAN. Occasional testing could be used to recalibrate what bandwidth is likely to be available for allocation. Any variances over past days and weeks could be noted to estimate what current bandwidth is likely to be. Download managers 116 could report when the allocated bandwidth cannot be achieved, which could trigger the global politeness coordination function 150 to lower its estimate of available bandwidth. Some allocations could be reduced to provide for streaming or other download tasks less able to operate adequately with lower bandwidth.

Interaction with the user interface 158 also allows control of the bandwidth and other network resources. Allocations of bandwidth and total bandwidth consumption over any time period can be specified through the user interface 158. For example, a fraction of the bandwidth, a datarate cap and/or a metering cap could be specified. The control could be for an IP address and/or ports. Some embodiments could control consumption for a range of IP addresses and/or ports. Instead of IP address, some embodiments could control based upon MAC address, domain or URI.

The user interface 158 could further be used to report historical usage and current download tasks. Any unserved or underserved tasks could also be reported. In some embodiments, reports on the type of usage could also be tracked. For example, recognized web services and protocols could be noted.

For consumers of the bandwidth without the intelligence to report and accept commands, allocations can be done presuming similar usage to past usage when activity is sensed on a particular port and/or IP address. Further, the protocol of the usage can be analyzed to determine if the protocol is likely to allow constraint of the Internet connection without unacceptable quality of service (QoS). For example, a particular VoIP protocol may be discerned to need 100 Kbps because of the port used and packets. Future use consistent with past use would also be allocated 100 Kbps.

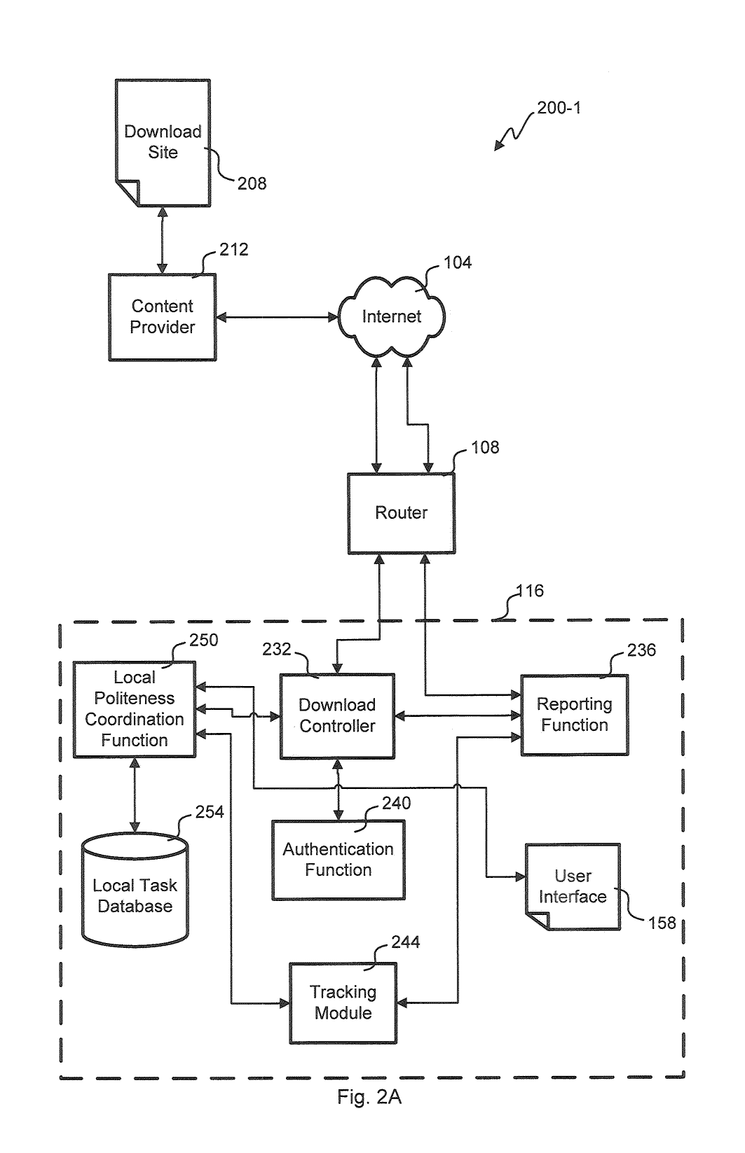

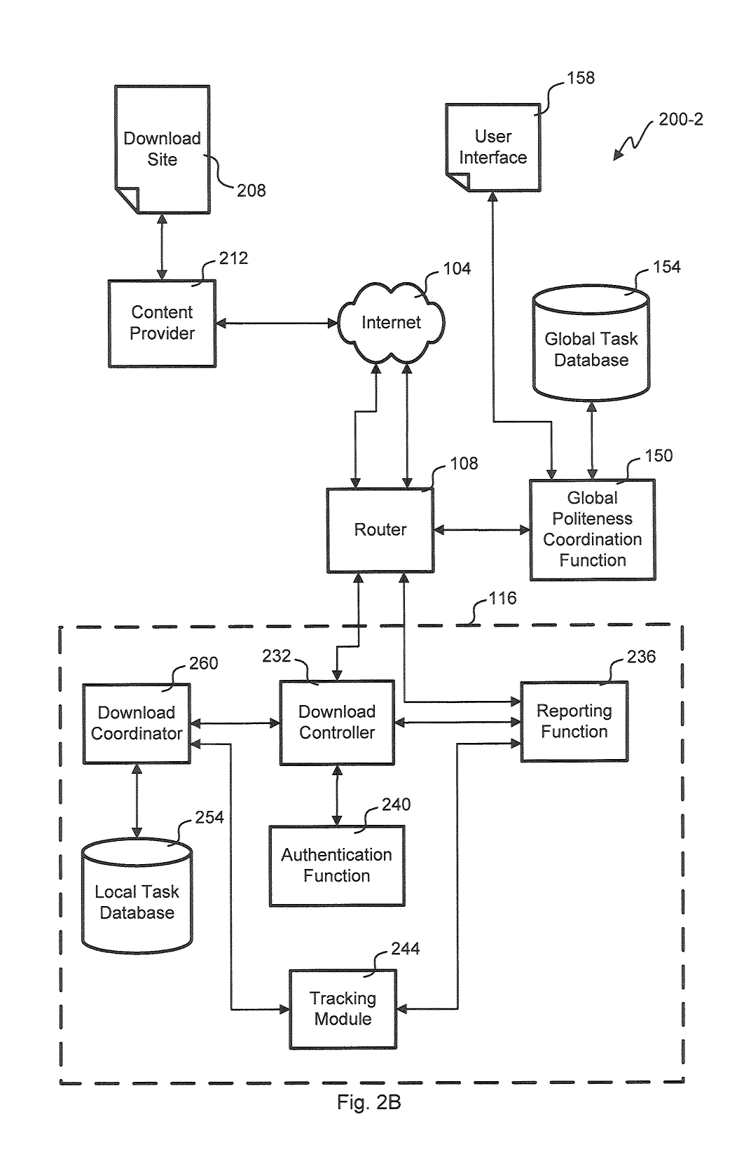

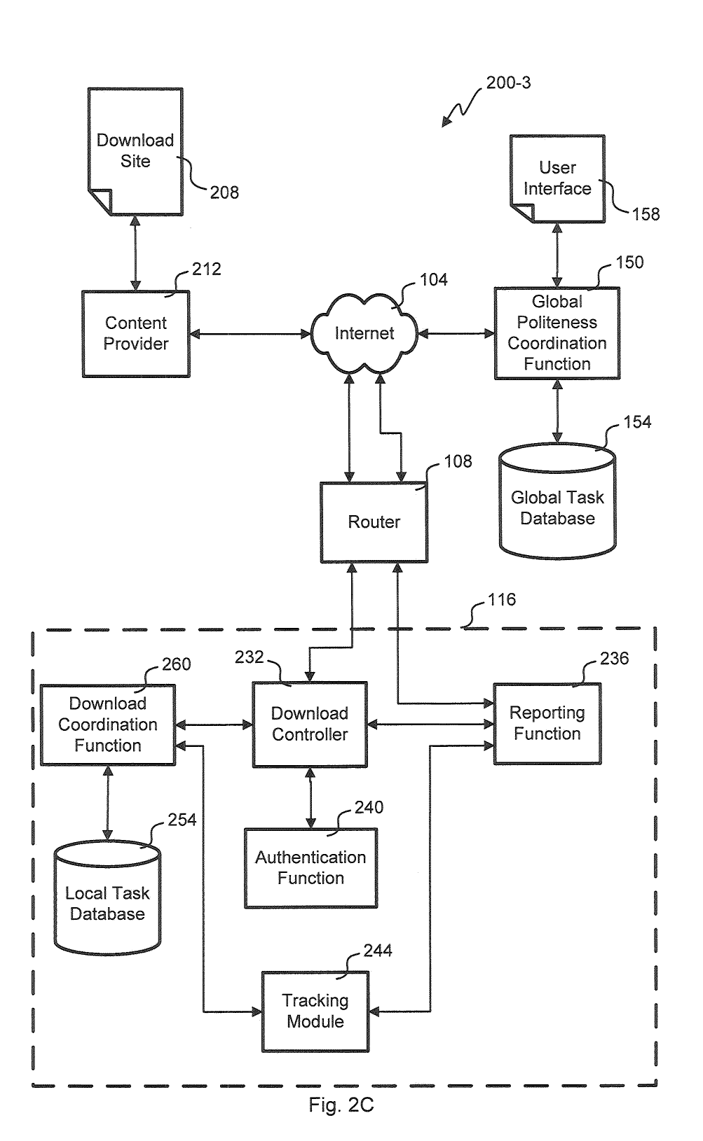

With reference to FIG. 2A, an embodiment of a download system 200-1 is shown. Included in the download system 200 are one or more content provider(s) 212 and one or more download managers 116. For simplicity sake, only a single download manager 116 and a single content provider 212 are shown, but it is to be understood that there would typically be many of each. A download controller 232 manages operation of the download manager 116. Configuration can be done and status is available with the user interface 158.

Instances of the download manager 116 are installed on computing devices 104 to facilitate download of content from various content providers 212. One instance of the download manager 116 can operate with any number of content providers 212. Various instances of the download manager 116 may be used cross-platform for any number of phones, personal digital assistants, media playing software or hardware, portable computers, desktop computers, set top boxes, personal video recorders, optical disc players, IP TV set tops, Internet radio, and/or other content realizing devices.

A tracking module 244 provides the ability to gather error reports, feedback, computer usage/inactivity and download task information. The information gathered and reported to all other local politeness functions 250 can be programmable. A reporting function 236 knows where to upload tracked information. In this embodiment, the local politeness coordination function 250 and all others on the LAN receive the tracked information. The download managers 116 find each other with automatic discovery.

The local politeness coordination function 250 stores the tracked information in a local task database 254. As all the other download managers 116 report their tracked information, the local politeness coordination function 250 can make decisions on how to consume the bandwidth to the WAN. One of the local politeness coordination functions 250 can be designated to make the decisions for the whole LAN, for multiple LANs, for a physical or logical subset or segment of the LAN, or the decision could be made in a distributed manner. In any event, all the local politeness coordination functions 250 act in concert to allocate and schedule the bandwidth in this embodiment.

The download manager 116 also includes an authentication function 240 in this embodiment. Users of the download manager 116 may have a user identifier (ID) and/or password depending on whether any authentication and/or authorization checks are required by the download manager 116. Where authentication is specified, the user enters a user ID once, periodically or every time the download manager 116 is invoked. Each user could have separate user IDs. The user IDs are unique within the realm of use case run on any number of computers, but could be overlapping when considering all users and use cases together. For example, one download manager 116 could have the user ID “WilliamBoy2”, which would be unique to all other download managers. Another download manager could have the same WilliamBoy2 user ID to correspond to the same or a different user.

The bandwidth available could be divided among the various download managers 116 sharing the LAN 100. For example, the computer may have 300 Kbps of available bandwidth. The download manager 116 could avoid or share use of the bandwidth to provide for other applications of the user computer. With the available bandwidth, some downloads could be given priority. For example, a streaming download of a live event could receive priority over a file download with little QoS requirements. The download manager 116 could go through a process of meeting minimum QoS requirements first to avoid stuttering of streamed content and divide the remaining portion of the bandwidth among the other downloads. A portion of the bandwidth could be reserved from use by the download manager 116 to provide for other applications, for example, the download manager could be limited to 80% of the bandwidth in one embodiment.

A politeness algorithm has awareness of the likely needs of the various download managers 116 in the LAN 100. In various embodiments, the politeness algorithm may execute in a distributed fashion, in the router, on the WAN or in another location coupled to the LAN. Specific download tasks are known by the politeness algorithm such that the bandwidth can be divided up in a reasonable manner. Download managers can optionally communicate the tasks and any quality of service (QoS) parameters. For example, a streaming program experienced live might take priority over a background download. The below table shows a number of download tasks for a given LAN 100 in one example.

TABLE
Download Tasks Across Download Managers in LAN

| | | Requested | | Allocated |
|---|---|---|---|---|
| Computing Device | Task Type | Bandwidth | | Bandwidth |
| PVR Download Manager | Stream of Video | 450 | Kbps | 450 Kbps |
| | Download of | 1.5 | Mbps | 100 Kbps |
| | Video | | | |
| | Download of | 350 | Kbps | 50 Kbps |
| | Software | | | |
| Radio Download Manager | Stream of Audio | 50 | Kbps | 50 Kbps |
| VOIP Phone | Duplex Streaming | 100 | Kbps | 50 Kbps |

| | | | |
|---|---|---|---|
| Unknown With Activity | Unknown | NA | 100 Kbps |
| Unknown Without Activity | Unknown | NA | 20 Kbps |

When a computing device is initially powered-on or reactivated, a certain amount of bandwidth is reserved by the politeness algorithm. The download manager 116 may report becoming active after booting or wake-up. Until a period of time after the recent activation/re-activation expires, the politeness algorithm reserves bandwidth. If none is consumed or if it is consumed at a rate less than the allocation, the reserved bandwidth is scaled back. Conversely, the bandwidth allocation can be scaled-up when the bandwidth is requested and consumed by the computing device.

Some use of the Internet connection is not from a download manager or other software that is designed to provide information to request bandwidth expressly. In the table, these are denoted as “Unknown” and an indication on whether there is current activity. A default amount of 100 Kbps is given these unknown requesters when one is actively requesting content and 20 Kbps is reserved even when no requesting is currently happening. If the default amount is not saturating the requests and the requester cannot be characterized, the bandwidth can be scaled until that happens to characterize the maximum bandwidth of the requester. Resources permitting, the maximum bandwidth can be made available. Characterizations can be stored so that future activity from an unknown requester can be accommodated more efficiently in this embodiment.

A fraction of the total bandwidth is reserved by the politeness algorithm for tasks other than those of the download managers 116. The politeness algorithm may or may not know of the planned usage of the bandwidth by other applications and processes. Where the information on the planned usage of the bandwidth can be gathered, the information is communicated to the politeness algorithm. If the information cannot be gathered, it is estimated. Where there is no visibility into usage of a browser, for example, how recently the computer has booted or been used after booting can be determined and communicated to the politeness algorithm. Where a computer is being used or recently has been booted, a fraction of the total bandwidth is allocated to that computer for unforeseen bandwidth consuming tasks. As bandwidth is consumed by the computer, more bandwidth can be allocated to the computer until the application(s) other than the download managers 116 are satisfied. For computer that have not been recently used, the fraction allocated to unexpected or unknown tasks can be scaled back over time.

Although an express request from a download manager 116 has a requested amount of bandwidth, the information provided can be more complex in other embodiments. The express request could have minimum, maximum and adequate bandwidth requests to allow the global politeness coordination function 150 more options in providing an allocation. Before an allocation, there can be a proposal or a number of proposals from which the download manager 116 can automatically choose or the user can manually select. For example, the global politeness coordination function 150 could offer to allocate the minimum bandwidth request immediately or the maximum bandwidth request if the allocation can be delayed by forty seconds.

In some cases, the download tasks cannot be scheduled to allocate the bandwidth necessary. Rather than under allocating multiple tasks, the politeness algorithm will choose some download managers 116 to receive their full allocation, while denying the full allocation to the minimum number of tasks. For example, the upstream bandwidth could be 1 Mbps. There could be four streaming tasks requiring 320 kbps. Rather than degrading the quality of all four download tasks providing globally bad QoS. Three receive full bandwidth and the fourth receives only 40 Kbps, which is the remainder. In other cases, the fourth download task could be given no bandwidth and an optional message could be displayed to the user by the download manager 116 indicating the problem. The displayed message could indicate when the active download tasks are scheduled to complete and to please try the request later, for example. The fourth download task could be automatically reinitiated or manually reinitiated once enough of the active download tasks complete to provide the necessary bandwidth.

Referring next to FIG. 2B, another embodiment of the download system 200-2 is shown. This embodiment uses a global politeness coordination function 150 on the LAN to manage consumption of the upstream bandwidth as described in relation to FIG. 1B above. The global politeness coordination function 150 can include hardware and/or software that can be in a separate appliance or embedded into the router 108. The politeness algorithm would operate in the global politeness coordination function 150 with information gathered from all download mangers 116 that are downstream from the router 108. A download coordination function 260 stores download tasks in a local task database 254 for reporting to the global politeness coordination function 150. Scheduling, allocation and status can also be stored in the local task database 254.

With reference to FIG. 2C, another embodiment of the download system 200-3 is shown. This embodiment uses a global politeness coordination function 150 that is located on the Internet or WAN upstream from the router 108. For example, the global politeness coordination function 150 could be in a neighborhood hub, a central office, a headend, a gateway, etc. The global politeness coordination function 150 can control one or more LANs 100. Reports of download tasks can be sent by the various download managers 116 over the Internet 104. In some embodiments, the global politeness coordination function 150 can artificially cap the upstream bandwidth by lowering the amount of bandwidth it will allocate. The router 108 enforces the allocation.

Some embodiments could allow an Internet service provider (ISP) regulate QoS to have premium levels of service or to enforce a fair access policy (FAP) with the global politeness coordination function 150. Download managers 116 could be regulated that premium users are provided a minimum QoS when an Internet connection is oversubscribed. When other users violate the FAP, their download managers and/or other bandwidth consumers could be throttled back to not use as many resources.

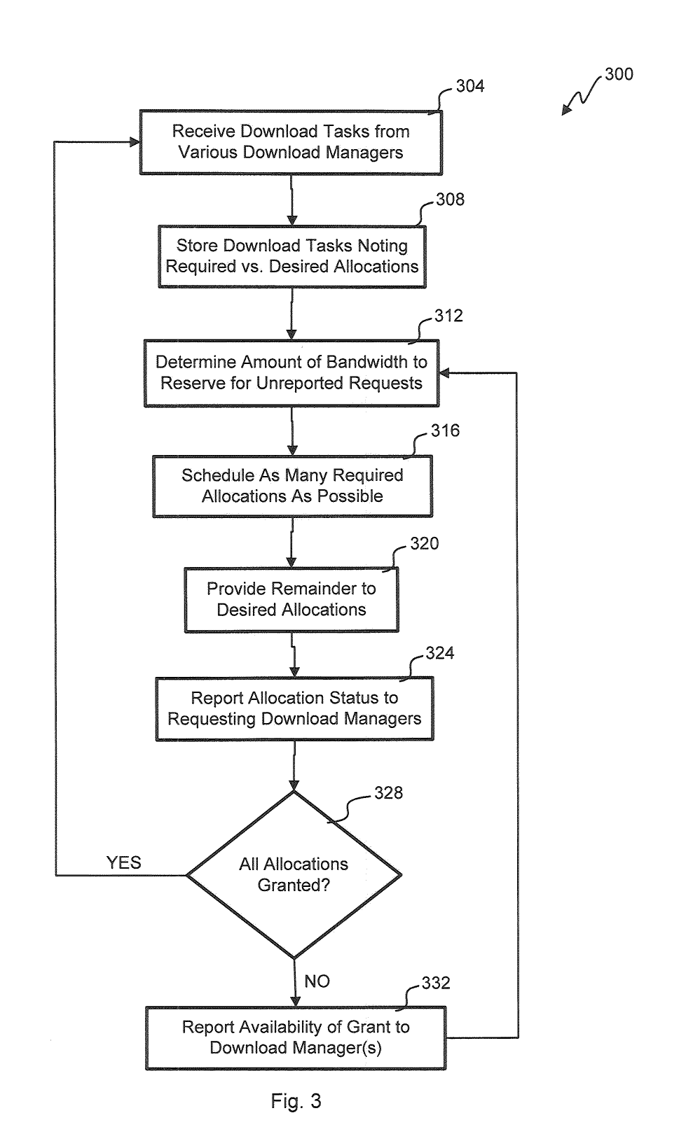

Referring next to FIG. 3, an embodiment of a process 300 for managing bandwidth consumption for a LAN 100 is shown. Embodiments could use a similar process to manage a number of LANs from an upstream point. The depicted portion of the process begins in block 304 where the download tasks are received from the various download managers 116 managed by a global politeness coordination function. A local and/or global task database 254, 154 stores the tasks in block 308. The required and desired allocations are noted in the database 254, 154. Required allocation is the amount needed before degradation in stream becomes noticeable. In some cases, a deadline for download may also dictate a schedule and/or allocation.

In block 312, the amount of bandwidth to reserve for unreported request is determined. This may include observation of usage, historical observations and/or analysis of computers recently booted or in-use. As many required allocations or schedules are met in block 316. If a required allocation or schedule cannot be wholly accepted, it may be rejected entirely in some embodiments. The remaining bandwidth is allocated to any desired allocations in block 320. This portion of the bandwidth can be oversubscribed in some embodiments where any required allocations are not active. The status of the allocation process is reported to all the download managers 116 in block 324. The download managers 116 receiving the allocation can begin or continue the consumption of the bandwidth after grant. Should allocation be exceeded because of a download manager 116 operating improperly, the bandwidth can be throttled by the router 108 and/or the global politeness coordination function 150.

If all allocations are granted as determined in block 328, processing loops back to block 304 to process more download tasks as they are received. Where some download tasks are denied, processing goes from block 328 to block 332. The availability is reported to download managers 116 in clock 332. This report could indicate when bandwidth will become available in the future such that the request process can be retried. The download manager 116 could optionally provide acceptance/denial status to the user. Processing loops back from block 332 to block 312 after the reporting.

If all accepted tasks are allocated with adequate QoS, some embodiments could allocate additional bandwidth to the unreported requests and/or reported requests to maximize usage. For example, a 1 Mbps Internet connection could have three express requests for 400 Kbps and one unreported request estimated to be 100 Kbps. Two express requests and the one unreported request are granted, but one 400 Kbps express request that is not. Any of the three granted requests could be given the unused 100 Kbps before the Internet connection saturates. Some embodiments could split the additional bandwidth among the three granted requests.

A number of variations and modifications of the disclosed embodiments can also be used. For example, the above embodiments speak in terms of regulation of downstream usage of the Internet connection. Other embodiments could use the same principles to regulate upstream usage of the Internet connection. Further, other embodiments could regulate usage of any WAN connection, which may or may not be an Internet connection.

While the principles of the disclosure have been described above in connection with specific apparatuses and methods, it is to be clearly understood that this description is made only by way of example and not as limitation on the scope of the disclosure.

What is claimed is:

1. A download system for electronically receiving content files from a plurality of sources with a plurality of user computing devices, the download system comprising:
a politeness coordination function in communication with the plurality of user computing devices;
a network interface coupled with a plurality of download managers distributed among the plurality of user computing devices, wherein the politeness coordination function gathers a plurality of download tasks from the plurality of download managers; and
a data store holding a download task list, wherein:
the download task list includes the plurality of download tasks reported from the plurality of download mangers,
each of the plurality of download tasks includes a requested bandwidth,
the download task list includes a plurality of unreported download tasks determined from automatically observing addresses sending or receiving information, and
the politeness coordination function allocates and/or schedules download task list over a wide area network (WAN) connection shared by the plurality of user computing devices.

2. The download system for electronically receiving content files from the plurality of sources with the plurality of user computing devices as recited in claim 1, wherein:
the politeness coordination function is within a router, and
the router is located on a local area network (LAN) between the WAN connection and the plurality of user computing devices.

3. The download system for electronically receiving content files from the plurality of sources with the plurality of user computing devices as recited in claim 1, wherein the politeness coordination function is located within one or more of the plurality download managers.

4. The download system for electronically receiving content files from the plurality of sources with the plurality of user computing devices as recited in claim 1, wherein:
the plurality of download tasks includes streaming tasks and non-streaming tasks, and
the politeness coordination function prioritizes streaming tasks differently from non-streaming tasks.

5. A method for controlling use of bandwidth to a wide area network (WAN) used by a local area network (LAN) including a plurality user computing devices, the method comprising:
accumulating a plurality of download tasks from a plurality of download managers distributed among the plurality of user computing devices, each of the plurality of download tasks indicating a desired bandwidth;
prioritizing the plurality of download tasks;
determining a fraction of the bandwidth for uses not reflected in the plurality of download tasks; and
allocating bandwidth for the plurality of download tasks.

6. The method for controlling use of bandwidth to the WAN used by the LAN including a plurality user computing devices as recited in claim 5, wherein the allocating is performed in a router between the WAN and the LAN.

7. The method for controlling use of bandwidth to the WAN used by the LAN including a plurality user computing devices as recited in claim 5, wherein the allocating comprises providing adequate bandwidth to a subset of the plurality of download tasks while denying any bandwidth allocation to some of the plurality of download tasks outside the subset.

8. The method for controlling use of bandwidth to the WAN used by the LAN including a plurality user computing devices as recited in claim 5, wherein the prioritizing is based upon some of the plurality of user computing devices having priority over others.

9. The method for controlling use of bandwidth to the WAN used by the LAN including a plurality user computing devices as recited in claim 5, wherein the determining divides the uses by requesting address and an estimation on an allocation needed for adequate QoS.

10. The method for controlling use of bandwidth to the WAN used by the LAN including a plurality user computing devices as recited in claim 5, notifying one of the plurality of download managers that submitted one of the plurality of download tasks that there will be no allocation of bandwidth to the one of the plurality of tasks.

11. The method for controlling use of bandwidth to the WAN used by the LAN including a plurality user computing devices as recited in claim 5, notifying one of the plurality of download managers that submitted one of the plurality of download tasks that there will be no allocation of bandwidth to the one of the plurality of tasks presently, but that the one of the plurality of tasks can be fulfilled at a later time.

12. The method for controlling use of bandwidth to the WAN used by the LAN including a plurality user computing devices as recited in claim 5, wherein the scheduling the plurality of download tasks includes only allocating as many streaming tasks as can be completely serviced.

13. The method for controlling use of bandwidth to the WAN used by the LAN including a plurality user computing devices as recited in claim 5, further comprising a step of automatically determining the plurality of download managers sharing an upstream connection coupled to the WAN.

14. The method for controlling use of bandwidth to the WAN used by the LAN including a plurality user computing devices as recited in claim 5, further comprising a step of characterizing a requester of bandwidth, without the ability to express a download task, to estimate bandwidth for providing adequate quality of service (QoS).

15. A download system for electronically receiving content files from a plurality of sources with a plurality of user computing devices, the download system comprising:
a politeness coordination function in communication with the plurality of user computing devices;
a network interface in communication with a plurality of download managers distributed among the plurality of user computing devices, wherein the politeness coordination function gathers a plurality of download tasks from the plurality of download managers; and
a data store holding a download task list, wherein:
the download task list includes the plurality of download tasks reported from the plurality of download mangers, and
the politeness coordination function allocates and/or schedules bandwidth over a wide area network (WAN) connection shared by the plurality of user computing devices.

16. The download system for electronically receiving content files from the plurality of sources with the plurality of user computing devices as recited in claim 15, wherein:
the politeness coordination function is within a router, and
the router is located on a local area network (LAN) between the WAN connection and the plurality of user computing devices.

17. The download system for electronically receiving content files from the plurality of sources with the plurality of user computing devices as recited in claim 15, wherein the politeness coordination function is located within one or more of the plurality download managers.

18. The download system for electronically receiving content files from the plurality of sources with the plurality of user computing devices as recited in claim 15, wherein:
the plurality of download tasks includes streaming tasks and non-streaming tasks, and
the politeness coordination function prioritizes streaming tasks differently from non-streaming tasks.
